(19) United States
(12) Patent Application Publication
(10) Pub. No.: US 2003/0093791 A1
(43) Pub. Date: May 15, 2003

(54) System and method for interactive television

(76) Inventors: Luc E. Julia, Oakland, CA (US); Joanes C. Espanol, Fremont, CA (US); Maklouf Serghine, Union-city, CA (US); Jehan G. Bing, Menlo Park, CA (US)

Correspondence Address: McDERMOTT, WILL & EMERY, 600 13th Street, N.W., Washington, DC, 20005-3096, US

(21) Appl. No.: 10/006,914

(22) Filed: Nov. 9, 2001

(51) Int. Cl. H04N 5/445

(52) U.S. Cl. 725/40

(57) ABSTRACT

A system and method for interactive television over a network includes a television, computer and at least one content provider connected to a network. Television content is transmitted to a television. Interactive content corresponding to the television content is transmitted to the computer via a network. A viewer using a computer with a graphical interface is able to respond to the interactive content and transmit commands to the television via the network.

### SPECIFICATION

1. Field of the Invention

The present invention relates generally to interactive television, and more particularly to a system and method by which a viewer can interact with a television over a network connection through the use of a small computer such as a palmtop, handheld or similar device having a screen-based user interface which may be directly manipulated by the user.

2. Background of the Invention

With a conventional television system, a viewer is limited to basic operations through which the viewer can interact with the television. For example, the viewer can change the channel or adjust the television volume, but essentially has no interaction with any of the televised content. For instance, when viewing a television game show, a viewer can shout an answer at the television, but the viewer cannot meaningfully compete with the contestants on the television program or with other viewers not watching the same television.

Rudimentary forms of interactive television have recently been introduced, but remain very limited in the extent to which a viewer may interact with a television set or program. For example, one form of interactive television presently available relies on digital cable service and an appropriate set-top box, and primarily allows the viewer to select a television program using an electronic programming guide (EPG) that is displayed on the television screen. Through the use of a menu button on a hand-held television remote control, a viewer can display an EPG (i.e., a listing of the television programs available to the viewer). Using the remote, the viewer can scroll through the list of programs, display a description of the programs, and ultimately select a program to view or record at the present time or at some future time (e.g., TIVO®). One drawback to this form of interactive television system is that, while the viewer is displaying the EPG, some or all of the television screen is obscured by the EPG even if the viewer had otherwise been watching a television program.

Other prior art forms of interactive television systems (e.g., Micrsoft's WebTV®) allow a viewer to use the television system to access such on-line services as e-mail, web sites and “chat” rooms. As with the digital cable offering, WebTV® requires a set-top box, which interfaces the viewer's television with the television content provider (i.e., the television network that provides the actual television programming), and the service that provides the interactive features (i.e., in the case of digital cable this features could be the electronic programming guide). As with digital cable, when the viewer attempts to interact with the WebTV®, at least part of the television screen must be used to display e-mail, etc., thus diminishing the size and quality of the television program being viewed. The interactive screen being displayed (e.g., a web page), may be difficult to read if the television screen is small, the resolution is low, or the viewer is not close to the television screen. Furthermore, with presently available interactive television it is difficult to manipulate the interactive screen using the remote control, wireless keyboard or remote pointer that are typically used with such systems. Consequently, what is needed is a system and method for efficiently interacting with the television without obscuring the underlying television program.

### SUMMARY OF THE INVENTION

The present invention overcomes limitations in prior art systems by providing a system and method for allowing television viewers to participate in interactive television, including obtaining relevant programming information, controlling a television or similar device over a network, and interacting with suitably enabled broadcasts from a small computer such as a palmtop, handheld or similar device having a screen-based user interface which may be directly manipulated by the user and is connected to that network for bidirectional communications. For purposes of simplicity, such small computers (i.e., small form factor) will be referred to as a “palmtop computer” herein. The palmtop computer typically incorporates a GUI, and may, for example, be Microsoft's Pocket PC, Sony's Tablet PC, Honeywell's WebPad, Compaq's iPAQ or other similar device rather than a conventional infrared or similar remote control unit. In one exemplary arrangement, the interface between the palmtop computer and the network is a wireless connection. In such an arrangement, the user is able to view programming information or other enriched content at the handheld device, and to control the television or similar device—or to respond to the enriched content of interactive broadcasts—without the need for any ancillary devices and without diminishing or obscuring the content displayed on the television.

With such a system, as the viewer watches a television program, a corresponding interactive program is broadcast via a network (e.g., the Internet, or alternatively a cable connection, in which case the signal may be translated in the set-top box) where it can be displayed on and controlled from a viewer's computer. If the viewer wishes to interact with the television program being broadcast, the viewer need only directly manipulate the graphical interface of the computer (e.g., by touching a finger or pen to the computer screen). In this manner, the viewer can interact with (i.e., play) conventional game shows (e.g., “Who wants to be a millionaire”), order commercial goods or services, and otherwise explore the enriched content of programs that have been adapted for interactive viewing.

In one embodiment, a television or other broadcast receiver, for example a videocassette recorder (VCR), act as satellites connected to a network, and interact as part of a multimodal interactive television system controlled using a palmtop computing device. In this exemplary embodiment, a broadcast is displayed on a conventional television and enriched content is displayed on the palmtop computer. Part of the rich enriched content is, for example, an electronic program guide such as that provided at Yahoo and other web sites, which the user can access and browse in order to display local current television program listings. The viewer can then select a program to be viewed by manipulating the palmtop computer, typically by use of a touchpad control or stylus as is characteristic of palmtop computers. In at least some embodiments, the viewer can also interact, via a computer, with multimedia recording and playback devices in order to play and record content.

In another embodiment, the devices or satellites connected to the network include home appliances such as the refrigerator, heater/air conditioning, spa, stove, and so on. In such an arrangement, a user can control various aspects of the kitchen appliances by directly manipulating the computer. For example, if the user wants to start the oven or adjust the temperature of the refrigerator, this can be accomplished remotely with the computer. Similarly, the user may wish to turn up the thermostat of a home heater in advance of arrival.

### BRIEF DESCRIPTION OF THE FIGURES

FIG. 1 is a system level diagram of the multimodal interactive television system according to an exemplary embodiment of the present invention.

FIG. 2 is a system level diagram of the multimodal interactive television system according to an alternate exemplary embodiment of the present invention.

FIG. 3A shows a television display of an interactive television program.

FIG. 3B shows a computer display of an interactive television program.

FIG. 4 shows a computer display of interactive television program listings.

FIG. 5 is a flowchart showing a computer interaction according to an exemplary embodiment of the present invention.

FIG. 6 is a flowchart showing user device selection according to an exemplary embodiment of the present invention.

### DETAILED DESCRIPTION OF THE INVENTION

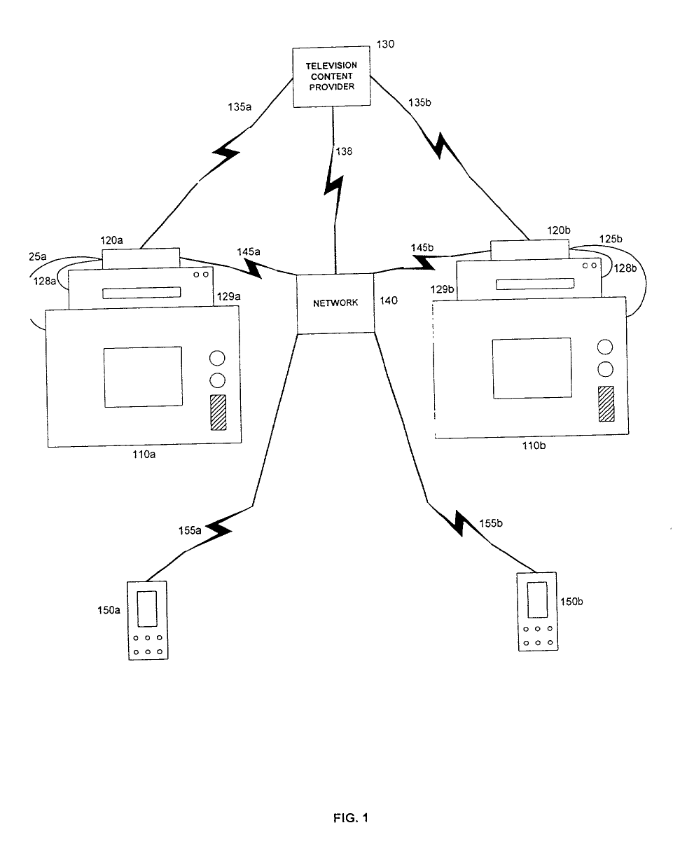

Referring to FIG. 1, an exemplary embodiment of the multimodal interactive television (“MiTV”) system in accordance with the present invention is illustrated in a system level diagram. As illustrated in FIG. 1, one or more viewers can hear and view television content while simultaneously having access to interactive content via network 140. In a preferred embodiment, network 140 may be the Internet, an intranet, a wide area network, an internal proprietary network, or any similar network environment and may, in many embodiments, include wireless connections. In FIG. 1, televisions 110a, 110b are coupled via set-top boxes 120a, 120b to television content provider 130, and network 140. In this system, a viewer can interact with television 110 using palmtop computer 150.

In the exemplary system depicted in FIG. 1, televisions 110a and 110b are operatively coupled with set-top boxes 120a and 120b, respectively, and receive television programming via television signals 135a and 135b from television content provider 130. Television signal 135 may be transmitted as a conventional analog VHF or UHF signal, a digital signal, or other signal format known to those skilled in the art. The television program transmitted via television signal 135 may include conventional non-interactive programming or interactive programming. In an exemplary embodiment which includes interactive television programming, television content provider 130 transmits an interactive version of a television program to network 140 via interactive signal 138. Interactive signal 138 may also include program content similar or corresponding to that of television signal 135, however, interactive signal 138 typically also includes interactive specific content, e.g., time markers, that allow viewers to interact with the television program using palmtop computer 150. Interactive signal 138 may also be provided by independent third parties, and need not be provided exclusively by television content provider 130.

Palmtop computers 150a and 150b are coupled to network 140 via network connection 155a, 155b respectively. In an exemplary embodiment, network connection 155 may be made with a wireless link, for example a WiFi signal compliant with the 802.11 (b) standard, or the home RF standard, or the Bluetooth standard, and other suitable wireless connection. Alternatively, the connection may be made with a conventional telephone connection, cable modem, or other high-speed network connection. Network connection 155 allows the viewer to interact with interactive signal 138 provided by television content provider 130 in addition to permitting the viewer to perform conventional Internet activities such as browsing the Internet, retrieving e-mails, and searching for television program listings. In one exemplary embodiment, television content provider 130 broadcasts television signal 135 containing a program, e.g., “Who wants to be a millionaire (Millionaire),” to set-top box 120. In an alternate embodiment, broadcast television signal 135 may be coupled directly to a suitably configured television 110, thus eliminating the need for a set-top box. Set-top box 120 is coupled using conventional television cable connection 125 to television 110, thus permitting the viewer to watch the selected program. Television content provider 130 also transmits interactive signal 138 to network 140. Interactive signal 138 may be, for example, an enriched content version of television signal 135 which includes interactive-specific information that allows viewers to interact with the program by manipulating a suitable interface device, which in the exemplary arrangement shown in FIG. 1 is palmtop computer 150.

For example, if the viewer is watching a game show such as “Millionaire,” the viewer can watch the conventional television broadcast of the program on television 110, while simultaneously viewing the enhanced content of the interactive version of “Millionaire” on palmtop computer 150. The nature of the enhanced content can vary from program to program. In one example, when questions are asked on the game show, the viewer can answer the questions by manipulating palmtop computer 150. The manipulation can be accomplished through hand writing recognition, typing an answer, voice recognition, or other palmtop computer data entry techniques known to those skilled in the art. In such an interaction, viewers can compete against other viewers as depicted in FIG. 1 by way of the interactive connections provided by palmtop computers 150a and 150b. Alternatively, the system of the present invention can emulate an environment so that a viewer can compete against the television contestants or, depending on the nature of the broadcast and the television program, could interface the remote users connected through the network of the present invention to interact directly with those in the studio. Alternatively, a plurality of viewers, each utilizing a palmtop computer 150 could compete against each other at the same location (i.e., a plurality of viewers viewing the same television 110 but each viewer using an individual palmtop computer 150). To alert a viewer that a television program has an interactive web-based component, television content provider 130 may broadcast via television signal 135 a logo. This logo may be similar to displaying the closed caption symbol on the television screen, indicating that some interactive component of the program exists.

As further illustrated in FIG. 1, set-top boxes 120a and 120b may be conventionally coupled to network 140 through the using of a cable modem, telephone line, or other network connection via signals 145a and 145b, respectively. With this configuration, palmtop computers 150a and 150b can, by virtue of the network connection from the palmtop computers 150a-b and the set-top box, emulate the function of conventional television remote controls. Thus, a user can manipulate palmtop computer 150a to, change television channels and adjust the television volume, or any other function normally provided by a remote control device for a television. In such an arrangement, the user's manipulation of palmtop computer 150a sends a command over network connection 155a to network 140. The command is then transmitted via signal 145a to associated set-top box 120a, and finally to television 110a via television cable connection 125a. It will be appreciated that not all implementations of the present system require each and every element described above; for example, as noted previously, not all televisions will require a set top box since that function may be integrated into the television itself.

In a further aspect of FIG. 1, it will also be appreciated that the present invention is not limited to interactions between the viewer and the television, but may also include control of other devices functioning in the home environment such as a VCR, etc. By way of further example, FIG. 1 depicts VCR 129a, 129b coupled to set-top box 120a, 120b via VCR cable connection 128a, 128b. Similarly as described above, Palmtop computers 150a-b can be used to emulate conventional VCR remote controls, thus allowing the viewer to manipulate the VCR with such commands as “record,” “play,” “pause” and “stop” and so on.

It will be appreciated that television signal 135 need not be provided solely by conventional broadcast technology. In an alternate embodiment (also shown in FIG. 1), television content provider 130 transmits the content to network 140, after which the television content is distributed over a network in a manner similar to signal 145. In this embodiment, television content is provided to set-top box 120 via a network connection rather than through a conventional television cable connection or antenna. This embodiment advantageously eliminates the need to have a separate set-top box 120 connection to television content provider 130 and network 140.

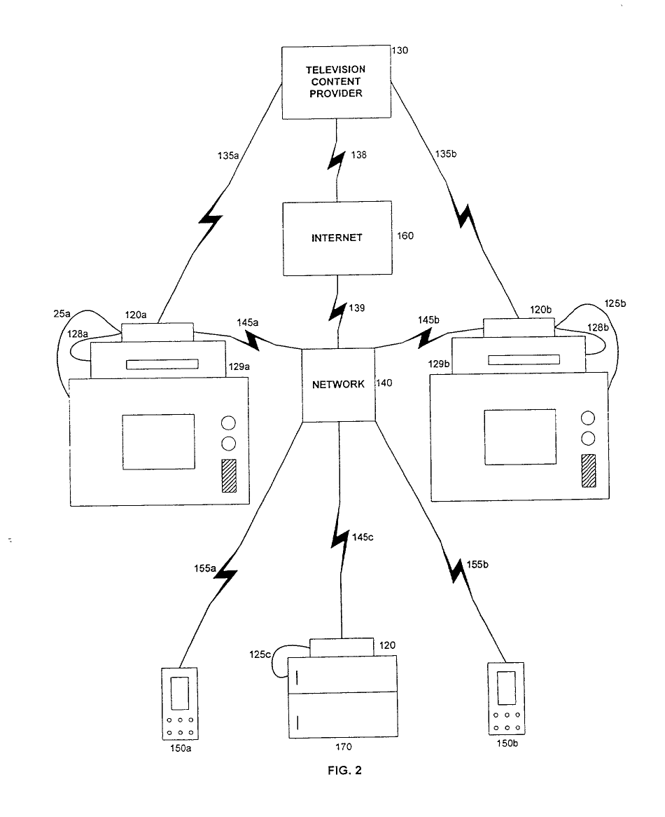

FIG. 2 is an alternate exemplary embodiment of the present invention as illustrated in FIG. 1, such that like elements are understood to have the description provided previously. As illustrated in FIG. 2, television content provider 130 transmits an interactive version of a television program via interactive signal 138. Interactive signal 138 is transmitted to Internet 160 (commonly referred to as the Internet or World Wide Web) where it can then be accessed through connection 139 which connects Internet 160 to a viewer's local network 140. Advantageously this configuration reduces the lag time associated with responding to interactive signal 138 by eliminating the need for the viewer's response to go to Internet 160. When the viewer manipulates palmtop computer 150, this interaction need only proceed between palmtop computer 150 and the viewer's local network 140. The interaction does not then need to be retransmitted to Internet 160 via connection 139. The utilization of local network 140 is particularly efficient if an entire interactive program (or a substantial portion thereof transmitted by content provider 130 is downloaded by the viewer to local network 140. In this case, rather than transmitting interactive signal 138 as a real-time signal concurrent with the broadcast of television signal 135, interactive signal 138 is broadcast prior to the broadcast of television signal 135 with the interactive content then locally stored for access by the viewer, allowing the viewer to interact with the content independent of viewing the television program. Local storage of interactive content eliminates the necessity to have an active Internet connection 139 while interacting with the interactive content. If synchronization between the interactive content and television content is required, the interactive content can be synchronized using time markers.

A reduction in lag time similarly applies when palmtop computer 150 is used to emulate a conventional television remote, thereby interacting with set-top box 120 to accomplish such functions as adjusting the television volume or changing the channel. In this case, a command from the viewer made on palmtop computer 150a (e.g., changing the channel) need only travel between palmtop computer 150a, local network 140, and set-top box 120a, thus eliminating the hops normally associated with communications over the Internet. As further illustrated in FIG. 2, the present invention is not limited to the interaction and control of such audiovisual devices as televisions and VCRs but instead can provide communications with any “smart” appliances or other network-connected devices. In the embodiment of FIG. 2, refrigerator 170 is coupled to set-top box 120c by way of connection 125c. Set-top box 120c, similar to set-top boxes 120a, 120b previously described, provides an interface to network 140 via connection 145c. Manipulation of palmtop computer 150a sends a signal over network connection 155a to network 140, and then back through connection 145c to set-top box 120c, thus allowing the access to or control of such features on refrigerator 170 as the refrigerator's temperature, inventory of contents, and so on. Further, and similar to the interactive television content that a viewer receives from television content provider 130, the user of refrigerator 170 can receive interactive content such as when to replace the refrigerator's air or water filters, maintenance and warranty information, and promotional material such as recipes or coupons. By way of further example, in the case of a refrigerator equipped with a water dispenser, refrigerator 170 can be configured to transmit information about water consumption to a billing agency or other monitoring entity via its local network connection 145c to Internet 160, similar to the transmission of the user's interactive signals to television content provider 130. Content provider 130, having monitored the water consumption of refrigerator 170 sends an interactive signal to palmtop computer 150a indicating that the water filter in refrigerator 170 requires replacement. By manipulating palmtop computer 150a (e.g., responding “yes” or “no”), a user can purchase a new water filter.

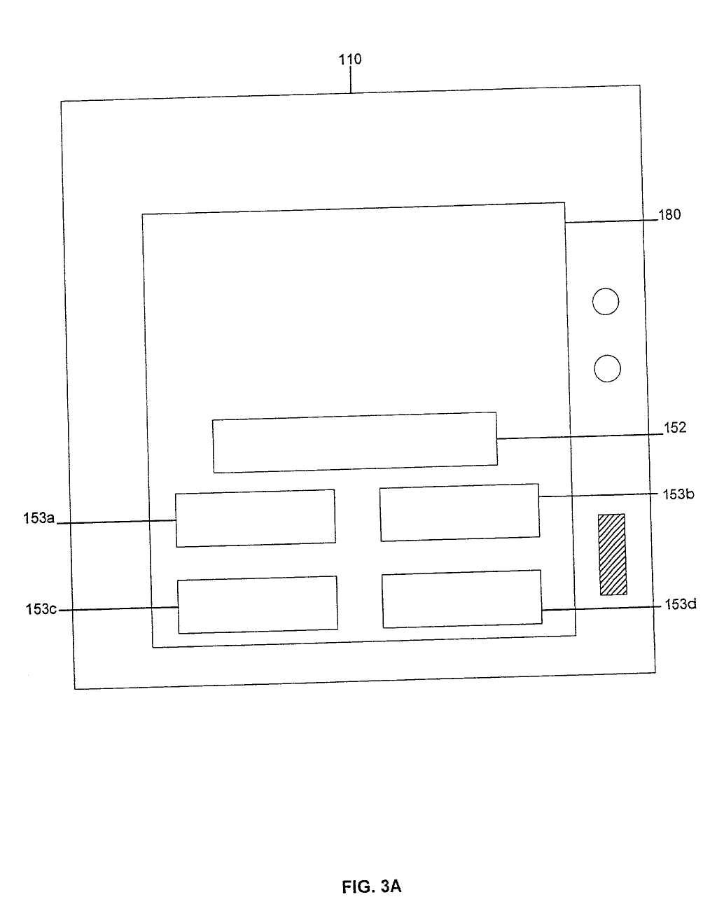

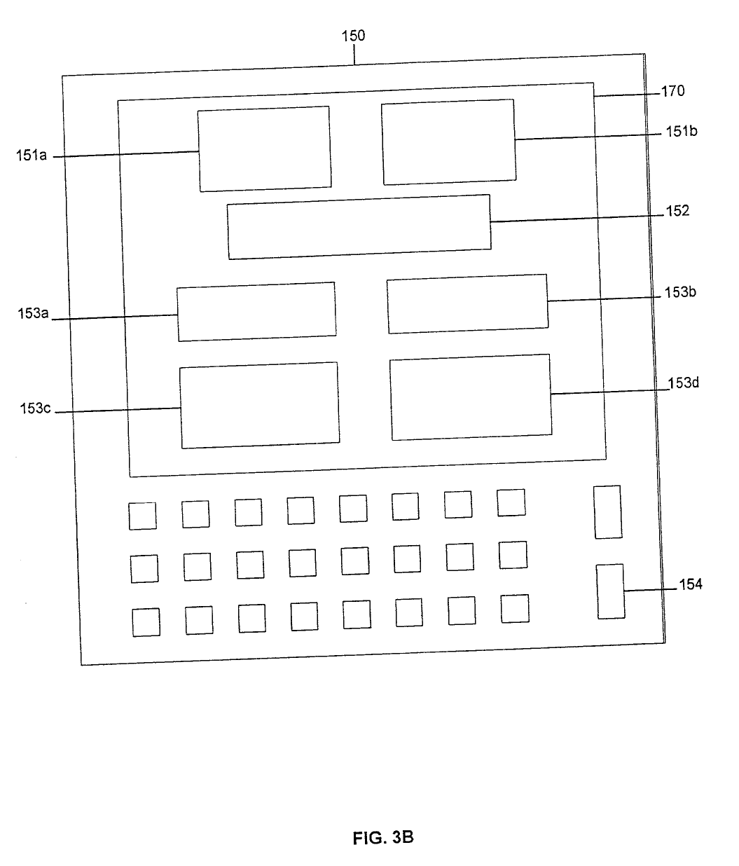

Referring now to FIG. 3A, a simplified exemplary version of a television 110 and a television screen 180 is shown, displaying a typical interactive television program. Generally, a television program such as “Millionaire” will display to the interactive viewer additional information not available to the conventional viewer, such as the names of the contestants, audience, host, and television studio set (not shown). Also, at least some arrangements may display text items such as text display 152 of the question being asked of the contestant and text displays 153a-d of the possible answers. Each of the enhancements will, in the present invention, be displayed on the palmtop computer 150.

Referring to FIG. 3B, there is shown therein a simplified exemplary version of palmtop computer 150 and computer display screen 170 used to interact with a typical interactive game show in the practice of the invention described herein. Palmtop computer 150 displays on its display screen 170 various interactive and non-interactive text fields. Text fields 151a, 151b display non-interactive text information, e.g., the viewer's game score, and the game scores of other viewers or contestants. Text field 152 is a non-interactive text version of the question being asked of the contestant. Text fields 153a-d represent interactive text versions of possible answers to the question asked of the contestant (or viewer). In order to select one of the possible answers, the viewer highlights one of the answers by directly manipulating the graphical user interface of the palmtop computer 150, e.g., by touching screen 170 or other method of direct manipulation not requiring a keypad. Once a selection is made, an answer selection command is transmitted as previously described.

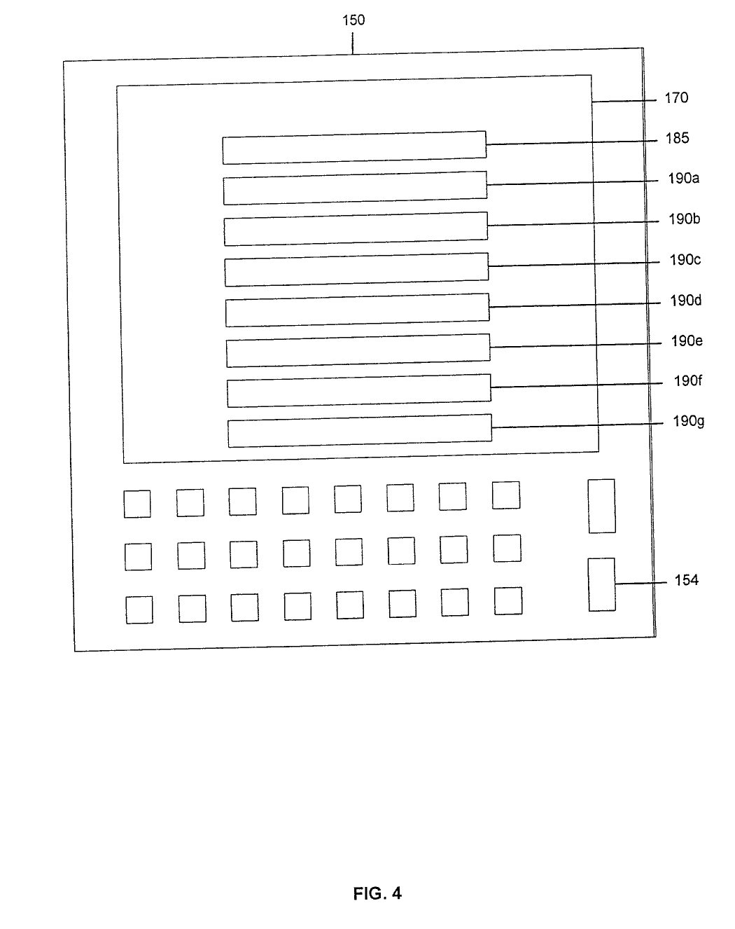

Referring next to FIG. 4, a simplified version is shown of how palmtop computer 150 and computer display screen 170 might be used to interact with a typical interactive television program listing in the practice of the invention described herein. As in FIG. 3B, palmtop computer 150 displays on its display screen 170 various interactive and non-interactive text fields. Text field 185 displays non-interactive text information, e.g., the current date and time, and the date and time corresponding to when television programs begin. Although not interactive, the viewer can change text field 185, e.g., displaying a different program listing start time, by manipulating palmtop computer 150. Text fields 190a-g represent interactive text versions of television program listings. In order to select one of the possible listings, the viewer directly manipulates Palmtop computer 150, e.g., by highlighting one of the listings, by touching screen 170, or through the use of keypad 154. Once a selection is made, a channel selection command is transmitted as previously described.

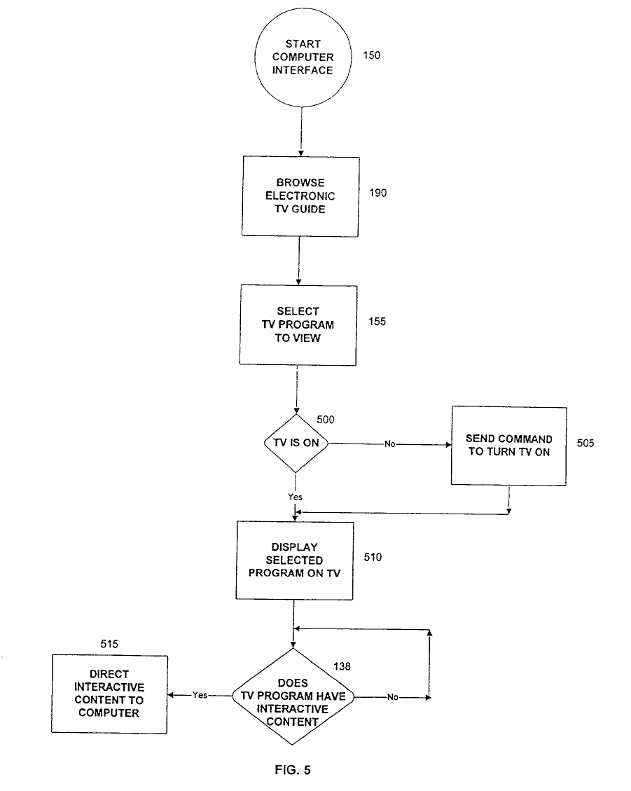

Referring to FIG. 5, a simplified interaction between a viewer and a typical interactive television program listing, such as that discussed in connection with FIG. 4, is shown in process flow form. A viewer starts computer interface palmtop computer 150, which displays various interactive and non-interactive text fields 190. The viewer can scroll through interactive text fields and then select a program to watch. Once the viewer makes a selection, for example by directly touching the touchscreen of the palmtop computer 150, a command 155 is sent to the set top box. If the television is not turned on as determined at step 500, then a command 505 is sent from palmtop computer 150 to set-top box 120 connected to television 110, to cause the television to be switched on. Once the television is turned on, the selected program is displayed at step 510. If the displayed television program also has enhanced interactive content 138, then this content is displayed at step 515 on palmtop computer 150, thus allowing the viewer to interact with the enhanced content.

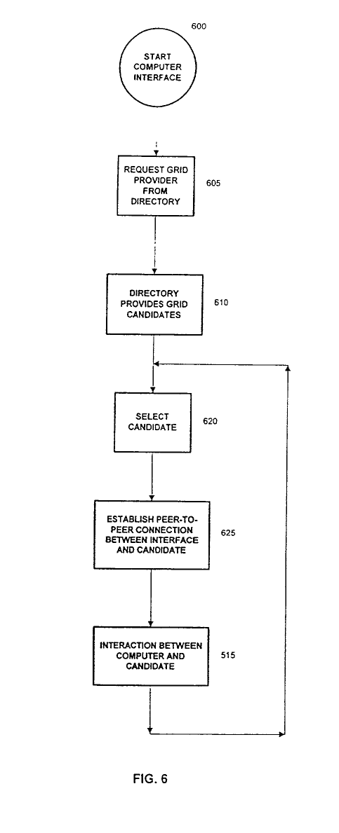

Referring to FIG. 6, what is shown is a simplified example of a viewer selecting which device to interact with. A viewer starts computer interface palmtop computer 150 at step 600, which then sends, at step 605, a request to its directory to provide a listing of grid providers. At step 610, each grid provider represents a listing of set-top boxes and the respective devices connected to the set-top boxes. For example, as previously illustrated in FIG. 2, set-top box 120a is connected to VCR 129a and television 110a, whereas set-top box 120c is connected to refrigerator 179. At step 620, a user can then select the candidate (i.e., the device) that the user wishes to interact with. Once the user makes the selection as to which device to interact with, a peer-to-peer connection is established at step 625. This peer-to-peer connection allows the user to directly interface between palmtop computer 150 and the selected device.

Thus, what is disclosed in the present invention includes a system and method of interacting with one or more devices, coupled to a network, with each device controlled through the use of a computing device. Having fully described a preferred embodiment of the invention and various alternatives, those skilled in the art will recognize, given the teachings herein, that numerous alternatives and equivalents exist which do not depart from the invention. It is therefore intended that the invention not be limited by the foregoing description, but only by the appended claims.

We claim:

1. A method of interacting with a device comprising the step of:
receiving from a network a signal, the signal sent to the network from a computer responsive to an input, wherein the signal facilitates the changing of a state of the device.

2. The method of claim 1 wherein the device is a television.

3. The method of claim 1 wherein the computer includes a graphical interface.

4. A method of interacting with a device coupled to a network comprising the steps of:
receiving from a network a signal generated by computer responsive to an input, the signal used to change a state of a device; and
transmitting the signal to a device.

5. The method of claim 4 wherein the device is a television.

6. The method of claim 4 wherein the computer includes a graphical interface.

7. A system for interacting between a computer and a device wherein the computer and device are connected to a network, the system comprising a computer with a graphical interface and a set-top box, wherein the set-top box receives from a network a signal generated by computer responsive to an input, the signal used to change a state of a device, and wherein the set-top box transmits the signal to a device.

8. A method for interacting with a device comprising the steps of:
receiving a signal at a first device;
receiving interactive content at a computer, the interactive content corresponding to a signal received at a device; and
displaying the interactive content on a display of the computer.

9. The method of claim 8 wherein the interactive content received at a computer is responsive to the signal received at a device.

10. The method of claim 8 wherein the interactive content is received at a computer simultaneous with the signal received at a device.

11. The method of claim 8 wherein the device is a television.

12. The method of claim 8 wherein the interactive content is received over a network.

13. The method of claim 8 wherein the second device is a computer.

14. The method of claim 13 wherein the computer has a graphical interface.

15. A method for interacting with a device comprising the steps of:
transmitting a signal to a device; and
transmitting interactive content to a computer, the interactive content corresponding to the signal transmitted to the first device.

16. The method of claim 15 wherein the device is a television.

17. The method of claim 15 further comprising displaying the interactive content on the second device.

18. The method of claim 15 wherein the interactive content is received over a network.

19. The method of claim 17 wherein the second device is a computer.

20. The method of claim 19 wherein the computer has a graphical interface.
